(19) United States
(12) Patent Application Publication
(10) Pub. No.: US 2026/0212691 A1
(43) Pub. Date: Jul. 23, 2026

(54) MITOSIS IDENTIFICATION THROUGH SELECTIVE MULTISTEP DEEP LEARNING ANALYSIS

(71) Applicant: Leica Biosystems Imaging, Inc., Vista, CA (US)

(72) Inventors: Ji Wang, Plainsboro, NJ (US); Hafez Eslami Manoochehri, Richardson, TX (US); Derek MILLER, Oceanside, CA (US); Ali Sheheryar ARSHAD, Ramona, CA (US); Payam KHORRAMSHAHI, San Diego, CA (US); Chad SALINAS, Rancho Santa Fe, CA (US)

(21) Appl. No.: 19/140,964

(22) PCT Filed: Jan. 26, 2024
(86) PCT No.: PCT/US2024/013072

§ 371 Date: Jun. 18, 2025

Related U.S. Application Data
(60) Provisional application No. 63/441,967, filed on Jan. 30, 2023.

(51) Int. Cl. G06V 20/69; G06V 10/25; G06V 10/26; G06V 10/52; G06V 10/764

(52) U.S. Cl. CPC G06V 20/698; G06V 10/25; G06V 10/26; G06V 10/52; G06V 10/764; G06V 20/695; G06V 2201/03

(57) ABSTRACT

Mitosis can be detected using a two step detection method. This type of a detection method may comprise, obtaining a detection output by applying a detection model to the tissue image. Subsequently, for each nucleus in a set of nuclei identified as undergoing mitosis in the detection output, making a certainty determination for that nucleus. Then, for each nucleus from a subset of nuclei, a classification model may be applied to that nucleus based on a relationship between a confidence for that nucleus and a first threshold. An output may then be provided which identifies each nucleus identified in the detection output as undergoing mitosis and for which the confidence is above the first threshold as undergoing mitosis. Additionally, the output may identify each nucleus from the subset of nuclei indicated as undergoing mitosis in the classification result obtained for that nucleus as undergoing mitosis.

### FIELD

The present disclosure relates to processing of histology images using deep learning technology in order to identify cells undergoing mitotic division.

### BACKGROUND

One of the most important topics in the field of microscopy imaging is the classification of cells, typically stained with hematoxylin and eosin (H&E) dye. In this area, one particularly challenging task is the detection of mitotic figures, i.e., cells undergoing division, in tumor tissue. Mitotic figures are defined histologically by the lack of a nuclear membrane and the presence of hairy projections of the chromosomes (nuclear material). A common method for quantification is the mitotic count (MC), which means counting mitotic figures in a standard-sized area located where the tumor is assumed to have the highest mitotic density. It is commonly accepted that the quantity of mitotic figures is one of the most powerful prognosticators of biological behavior for many tumor types, both in humans and animals. However, there are many difficulties associated with this type of mitotic counting. For example, even when histological images are annotated by pathologists, studies have found that there can be significant disagreement, on the order of 17-34% between human annotators in distinguishing individual mitotic figures from other cell structures. Algorithmic approaches can similarly suffer from difficulty in distinguishing between mitotic figures and other cell structures, and can also be expensive in terms of time and required computational resources applied to attempt to account for the difficulty in the mitotic counting task. Accordingly, there is a need for improvements in technology used to automatically identify mitotic figures in histological images.

### SUMMARY

The technology disclosed herein is susceptible to being implemented in a variety of manners. For example, it may be implemented to provide a method for mitosis detection in tissue images with two step detection. Such a method may comprise receiving a tissue image. After receiving the tissue image, the method may proceed with obtaining a detection output by applying a detection model to the tissue image. In this type of method, the detection output may comprise, for each of a set of nuclei in the tissue image, an identification of that nucleus as undergoing mitosis, and a confidence for the identification of that nucleus as undergoing mitosis. A method such as described may also include, for each nucleus from the set of nuclei, making a certainty determination comprising determining a relationship between the confidence for that nucleus and a first threshold. Following this determination, the method may include, for each nucleus from a first subset nuclei, based on the relationship between the confidence for that nucleus and the first threshold, obtaining a classification result indicating if that nucleus is undergoing mitosis by applying a classification model to that nucleus, wherein, for each nucleus from the first subset of nuclei, the confidence for that nucleus is not above the first threshold. Finally, the method may include providing an output, wherein the output identifies each nucleus from the set of nuclei identified in the detection output as undergoing mitosis and for which the confidence is above the first threshold as undergoing mitosis. The output may also identify each nucleus from the first subset of nuclei indicated as undergoing mitosis in the classification result obtained for that nucleus by applying the classification model as undergoing mitosis.

Other types of implementations, including in the form of systems and computer readable media for performing methods as described, are also possible and will be immediately apparent to those of skill in the art in light of this disclosure. Accordingly, the example method provided in this summary should be understood as being illustrative only, and should not be treated as limiting.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 depicts a detection model architecture which can be used to detect mitosis and mitosis look alike nuclei in an image;

FIG. 2 shows how a transformed image may be conceptualized as being covered by multiple sets of anchor boxes;

FIG. 3 shows an example of a process which may be used to create an annotated image;

FIG. 4 provide a diagram showing how two stages could be used to extract features at different resolutions, and how the outputs of those stages could be combined in the process of creating an annotated image;

FIG. 5 illustrates a method which can improve upon identifications of mitosis and mitosis look-alike nuclei such as may be provided by a detection model; and

FIG. 6 is a block diagram of a computing apparatus that may be used to implement aspects of the disclosed technology.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The present disclosure relates to apparatus, systems, and methods for identifying mitotic figures in histological images. As set forth in detail herein, this type of mitotic figure identification can be performed in a selective multi-step manner, in which a detection model is used to detect mitosis and mitosis look-alike nuclei patches in an image, and a classification model is used to classify nuclei patches whose detection as mitosis or look-alike patches was uncertain. By taking this type of selective multi-step approach, the disclosed technology can allow for improvements in accuracy and/or time cost relative to other types of mitosis detection.

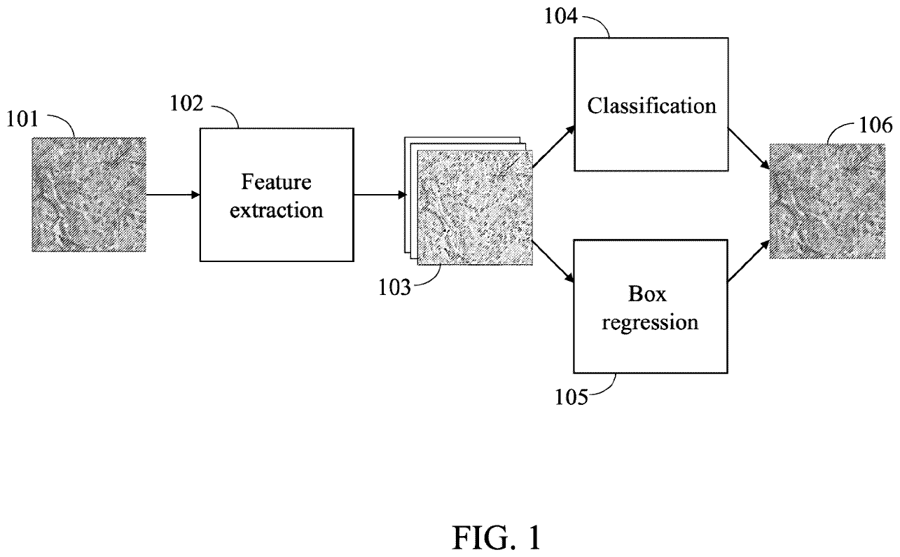

To illustrate how the disclosed technology could be implemented, FIG. 1 depicts a detection model architecture which can be used to detect mitosis and mitosis look-alike nuclei in an image. In the architecture of FIG. 1, an input image 101, such as a portion of an H&E stained tissue image could initially be provided to a feature extraction network 102. The feature extraction network 102 may then apply a set of filters to the input image 101 to obtain a transformed image 103 having a channel for each of the filters applied to by the feature extraction network 102. For example, a feature extraction network 102 may include a first filter shown such as shown in table 1, that could be convolved with the input image 101 to identify vertical edges, and a second filter such as shown in table 2, that could be convolved with the input image 101 to identify horizontal edges.

TABLE 1
[−1 0 1]
[−2 0 2]
[−1 0 1]

TABLE 2
[1 2 1]
[0 0 0]
[−1 −2 −1]

The outputs of these filters could then be combined into a transformed image 103, with the image created with the first filter being treated as a first channel in the transformed image 103, the image created with the second filter being treated as a second channel in the transformed image 103, and any other images created with other filters being treated as other channels in the transformed image 103.

Once the transformed image 103 has been created, in a system using the detection model architecture of FIG. 1, the features in the transformed image 103 could be used to identify mitosis and look-alike nuclei, and their locations. As shown in FIG. 1, this may be done by processing the transformed image 103 in parallel using two different networks, a classification network 104 and a box regression network 105. The roles played by each of these networks, as well as a discussion of how they may potentially be implemented, are discussed below.

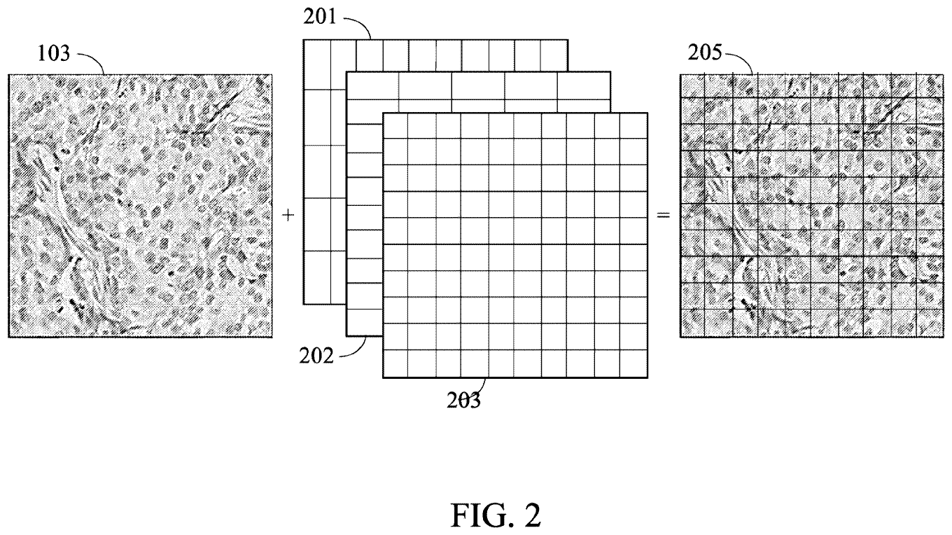

Turning first to the classification network 104, this network may be used to generate, for each of pixel in the transformed image 103, indications of the confidence at which an anchor box at that location could be classified as depicting a mitosis or mitosis look-alike nucleus. To illustrate, consider FIG. 2, which shows how a transformed image 103 (for ease of understanding, shown flattened rather than as a superposition of individual channels) may be conceptualized as being covered by multiple sets 201 202 203 of anchor boxes. These sets of anchor boxes 201 202 203 each form a tiling over the transformed image 103, with a first set of anchor boxes 201 comprising anchor boxes having a 1:2 aspect ratio, a second set of anchor boxes 202 comprising anchor boxes having a 2:1 aspect ratio, and a third set of anchor boxes 203 comprising anchor boxes having a 1:1 aspect ratio. These sets of anchor boxes 201 202 203 can be superimposed on the transformed image 103, resulting in a processing image 204 in which each pixel in the transformed image 103 is covered by one anchor box from each of the sets 201 202 203 of anchor boxes (i.e., each pixel is covered by one 1:2 anchor box, one 2:1 anchor box, and one 1:1 anchor box).

In order to provide indications of the confidence at which anchor boxes at each location in the transformed image 103 could be classified as depicting a mitosis or mitosis look-alike nucleus, a classification network 104 could be made up of one or more preparation layers, in which each preparation layer comprises a convolution filter such followed by an activation function, and in which the output of one preparation layer would be provided as input to the next. For example, a first preparation layer may take the transformed image 103 as input, convolve that transformed image with a 3×3 filter such as shown in table 1 or table 2, and then apply an activation function (e.g., a ReLU activation) to each pixel in the convolved transformed image to obtain an output which would be provided as input to a second preparation layer, and so one until each of the one or more preparation layers making up the classification network had been applied. A classification network 104 may also include an output layer which would apply one filter for each set of anchor boxes and each set of classes (e.g., in a case where there were three sets of anchor boxes and three potential classes of objects to be identified, a total of nine filters) followed by applying an activation function (e.g., a sigmoid activation function) to provide a value for each anchor box and each class of each pixel in the transformed image. These values may then be treated as confidence values for each of the potential identification (e.g., in a case where two filters were applied for each anchor box in the output layer, the result of applying the activation function to the value provided by the first filter could be treated as the confidence for mitosis, and the result of applying the activation function to the value provided by the second filter could be treated as the confidence for mitosis look-alike). Alternatively, in some cases, some additional processing could be applied to obtain confidence values. For example, in a case where the classification network 104 uses classes of mitosis, mitosis look-alike and background, a softmax function could be applied to the class values for each anchor box to provide a confidence value with which each anchor box could be assigned to each class.

Turning next to the box regression network 105, that network may operate in a manner similar to that discussed above for the classification network 104. That is, it may use sets of anchor boxes and one or more preparation layers followed by an output layer to generate values for each anchor box from the applied sets of anchor boxes. However, while a box regression network 105 may operate in a similar manner to the classification network 104, there may also be some differences. For example, while the discussion of the classification network 104 described how its output layer could apply a filter for each class and each anchor box, an output layer of a box regression network may simply apply four filters for each anchor box, thereby providing, for each pixel, four values for each anchor box covering that pixel. These values may then be treated as encoding left, right, top and bottom offsets of the relevant anchor box relative to the actual bounding box for any nuclei which may exist (in whole or in part) in that anchor box.

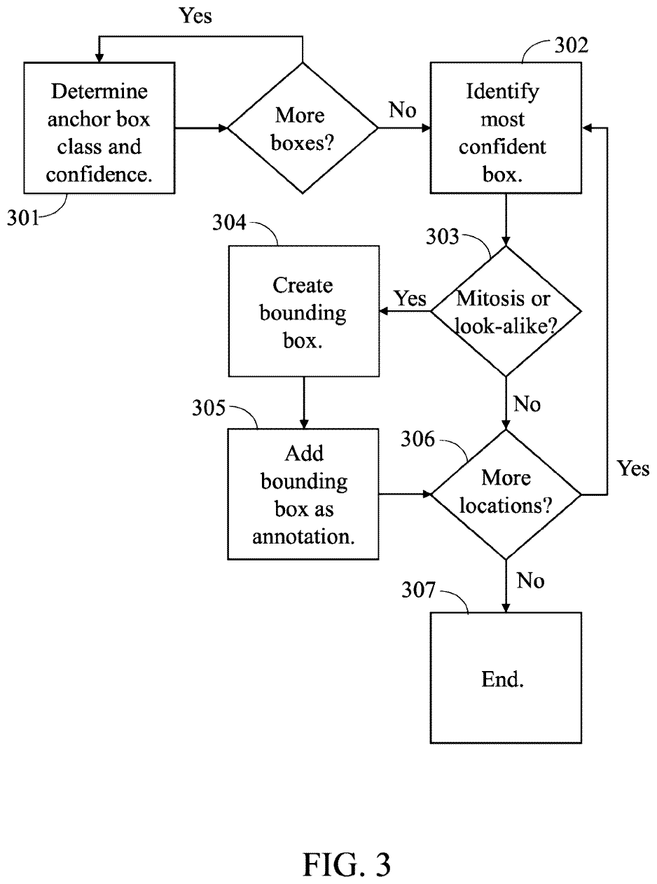

In a system using the architecture of FIG. 1, after the classification and box regression networks 104 105 have been applied, the outputs of those networks can be used to create an annotated image 106. An example of a process which may be used for this purpose is shown in FIG. 3. Initially, in that process, a class and confidence may be determined 301 for one of the anchor boxes from the processing image 205. This may include initially determining an anchor box's class, such as by looking at the highest confidence class for each pixel covered by the anchor box and treating the anchor box as having the class corresponding to the greatest number of covered pixels. This class may then be used to determine a confidence for the anchor box, such as by averaging the highest confidences of each pixel whose highest confidence class is the same as the class for the anchor box. This may then be repeated until a class and confidence had been determined 301 for each anchor box in the processing image (i.e., for every anchor box in each of the sets of anchor boxes 201 202 203).

Once a class and confidence had been determined for each anchor box, the process of FIG. 3 could continue with identifying 302 a most confident box for a location in the processing image 205. This may be done by, for each of the anchor boxes covering the location in the processing image, determining which of those boxes had the highest confidence as previously determined 301. A determination 303 may then be made of whether the most confident anchor box depicted a mitosis or mitosis look-alike nucleus. In a case where the classes assigned by the classification network 104 included mitosis nucleus, mitosis look-alike nucleus, and one or more other classes, this determination 303 may be performed by simply checking if the class for the most confident anchor box was either mitosis nucleus or mitosis look-alike nucleus. Alternatively, in a case where the classification network 104 assigned only classes of mitosis nucleus and mitosis look-alike nucleus, this determination 303 may be performed by checking if the confidence value for that anchor box was below a threshold separating boxes which were reasonably likely to actually depict either a mitosis nucleus or a non-mitosis nucleus from boxes which were not reasonably likely to depict either of those types of nucleus. The process of FIG. 3 may then determine 306 if there were more locations (either directly, or after creating 304 and adding 305 a bounding box as described below), such as by checking if there were any locations not covered by an anchor box which had not been subject to the determination 303. If there were more locations, the process could proceed to the next location (e.g., a location not covered by a previously processed anchor box), and repeat the above described identification 302 and determination 303. Otherwise, if no locations remained, the process could end 307, such as by providing an annotated image 106 comprising identifications and bounding boxes for mitosis and/or mitosis look-alike nuclei in the original input image 101.

Returning now to the determination 303 of whether an anchor box depicted a mitosis nucleus or mitosis look-alike nucleus, if the anchor box did depict such a nucleus, then a bounding box may be created 304 from that anchor box. This may be done, for example, by combining (e.g., averaging) the offsets determined by the box regression network 105 for each of the pixels covered by the anchor box in question, and then moving the top, bottom, left and right sides of the anchor box based on those combined offsets. Once it is created 304, the anchor box may be added 305 as an annotation to the annotated image. This may be done by adding the bounding box and/or the associated class as metadata that could be displayed in a separate layer on the annotated image, by directly adding the shape of the bounding box on a copy of the input image 101 in a color corresponding to the appropriate class, or whatever other way may be appropriate to show where the appropriate nucleus could be found in the input image, given the constraints of, and likely applications supported by, a particular embodiment. Once the bounding box had been added 305, if it was determined 306 that there were more locations, the process could continue at the next location or, if all locations had been processed, then the method could end 307, with all mitosis and mitosis look-alike nuclei from the original input image 101 having been detected and marked up on the annotated image 106.

When implementing a system such as described in the context of FIG. 1, the various parameters of the various networks will likely be trained using a dataset comprising a large number of images in which mitosis and mitosis look alike nuclei, and their associated bounding boxes, have been identified. Such a dataset may be obtained for example, by simply asking a human subject matter expert to identify the mitosis nuclei and mitosis look alike nuclei in the training images, and then applying bounding boxes to those nuclei, either by the human subject matter expert adding the bounding boxes, or automatically by placing bounding boxes over the nuclei based on the size the nuclei would be expected to have in a given image. Alternatively, in some cases a panel of human reviewers may be asked to independently identify mitosis nuclei in the training images. In such a case, nuclei which were identified as mitosis nuclei by all of the panel members (either initially or after consultation), or which were identified as mitosis nuclei by a majority of panel members (if no consensus could be reached) could be treated as mitosis nuclei, while nuclei which were initially identified as mitosis nuclei by at least one panel member but which were not ultimately identified as mitosis nuclei could be treated as mitosis look-alike nuclei. The images could then be used to train the networks by providing the differences between the outputs of the various networks and the actual correct identifications and bounding boxes as feedback using a loss function which down-weights easy determinations so that they do not dominate the training and overwhelm learning which may be provided by hard cases. An example of such a loss function is provided below as equation 1, though other types of loss functions, such as cross entropy loss or balanced cross entropy loss are also possible, and could be used in some cases.

$$Loss ( {p}_{t} ) = - {( 1 - {p}_{t} )}^{γ} * log ( {p}_{t} ) \qquad Equation 1$$

In equation 1, pₜ is equal to the ground truth if the ground truth value is equal to 1, and is otherwise equal to 1−p, where p is the value provided by the network being trained. γ is a tunable parameter with a value preferably between 0 and 5, inclusive.

While the discussion above described how an architecture such as shown in FIG. 1 could be used to detect mitosis and non-mitosis nuclei, it should be understood that that discussion is intended to be illustrative only, and that numerous variations on that discussion are possible and could be utilized in systems implemented based on this disclosure. For example, while the above discussion described how classification and box regression networks 104 105 could use convolution filters to provide their outputs (including confidence values) other types of implementations for the classification and box regression networks 104 105 are also possible, and will be immediately apparent to those of skill in the art in light of this disclosure. For example, those networks could be implemented using one or more dense layers—i.e., neural networks which take as inputs all of the values produced by the preceding networks. Similarly, while the examples given in tables 1 and 2 were of 3×3 filters, other dimensions of filters, such as larger filters (e.g., 4×4, 5×5) or smaller filters (e.g., 2×2 or 1×1) are also possible, and could be used in addition to, or as alternatives to, 3×3 filters such as shown in tables 1 and 2.

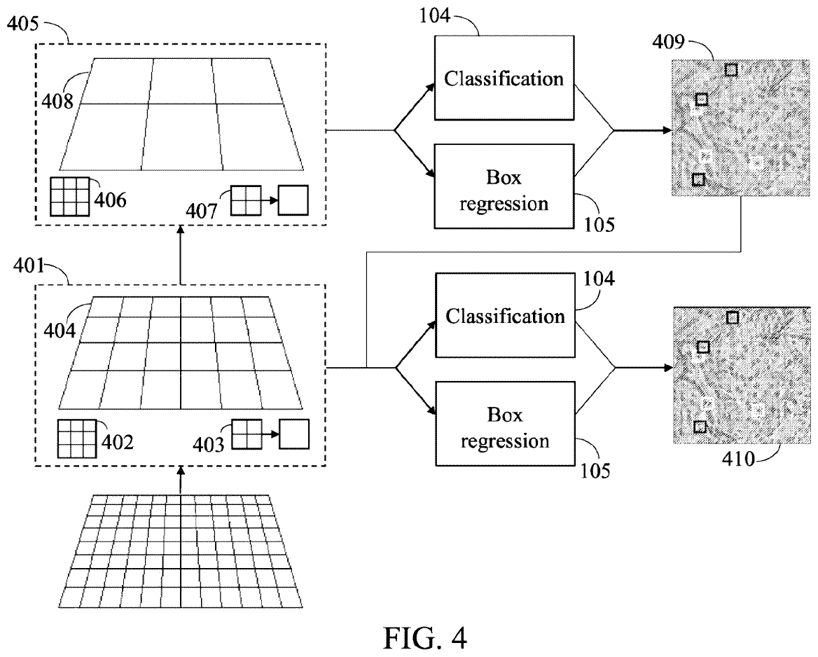

Variations are also possible in other aspects of FIG. 1, such as in potential implementation of the feature extraction network 102. For example, in some cases, a feature extraction network 102 may include multiple stages, such as may facilitate the identification of features which may be more apparent at different scales. The outputs of the various stages could then be used to create a set of intermediate annotated images, intermediate annotated images could ultimately be combined into a final annotated image 106 such as shown in FIG. 1. To illustrate, FIG. 4 provides a diagram showing how two stages could be used to extract features at different resolutions, and how the outputs of those stages could be combined in the process of creating an annotated image 106. In the diagram of FIG. 4, a high resolution input (which, if there were only two stages, would be the input image 101, and, if there were more than two stages, would be the output of a preceding stage) is provided as input to an intermediate stage 401. At the intermediate stage 401, the high resolution input would be convolved with one or more filter(s) 402 to obtain a high resolution feature map. That high resolution feature map would be downsampled using a pooling operation 403 (e.g., an operation which would replace the values in a 2×2 window with a single value, such as the average or maximum of the values in the original window) to generate a reduced resolution output 404. This reduced resolution output 404 would then be provided as input to a terminal stage 405, which would use its own filter(s) 406 and pooling operation 407 (each of which may be the same as, or different from, the corresponding item used at the preceding stage) to create a terminal resolution feature map 408.

Once it was created, the terminal resolution feature map 408, could be provided as input to, and processed by, classification and box regression networks 104 105 in a manner similar to that described in the context of FIG. 1 for generating an annotated image 106 from a transformed image 103. The result of this processing, would be an annotated image at the terminal resolution 409, could then be combined with the output of the next highest resolution stage 401 (e.g., by upsampling the result of processing the terminal stage's output, and then performing pixelwise addition with the output of the next higher resolution stage). The result of this combination could then be processed by classification and box regression networks 104 105 (which networks are depicted as the same as the those used to process the output of the terminal stage, though they may be different in some implementations), and they could provide an annotated image at the resolution of the intermediate stage 401. This process could then be repeated for however many stages are present in the applicable implementation, until a final high resolution annotated image 106 was created.

Other variations beyond the multi-stage processing of FIG. 4 and the variations on classification and box regression networks described in the context of FIG. 1 are also possible. For example, mitosis and mitosis look-alike nuclei could be detected using approaches such as described in Shaoqing Ren, Kaiming He, Ross Girshick, and Jian Sun, Faster R-CNN: Towards Real-Time Object Detection with Region Proposal Networks, arXiv:1506.01497; Joseph Redmon, Santosh Divvala, Ross Girshick and Ali Farhadi, You Only Look Once: Unified Real-Time Object Detection, arXiv:1506.02640; Tsung-Yi Lin, Priya Goyal, Ross Girshick, Kaiming He, Piotr Dollar, Focal Loss for Dense Object Detection, zarXiv: 1708.02002; and Tsung-Yi Lin, Piotr Dollar, Ross Girshick, Kaiming He, Bharath Hariharan and Serge Belongie, Feature Pyramid Networks for Object Detection, arXiv:1612.03144, each of which is hereby incorporated by reference in its entirety. Accordingly, the above discussion of how mitosis and mitosis look-alike nuclei could potentially be detected should be understood as being illustrative only, and should not be treated as limiting.

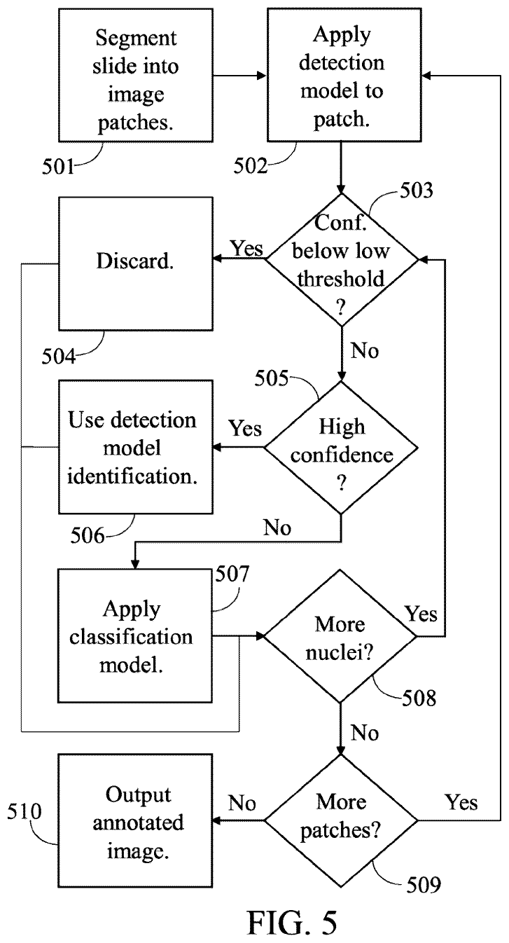

Turning now to FIG. 5, that figure illustrates a method which can improve upon identifications of mitosis and mitosis look-alike nuclei such as may be provided by a detection model as described above. As shown in that figure, the identification may begin with segmenting 501 an image of slide of an H&E stained tissue into a plurality of patches. For example, in a case where a method such as shown in FIG. 5 is performed using a detection model which is configured to detect mitosis and mitosis look-alike nuclei in 256×256 pixel areas, this segmentation 501 may be performed by separating a much larger image of a slide of an H&E stained tissue into a set of 256×256 pixel patches.

Once an image has been segmented 501 into patches, a detection model may be applied 502 to a patch. This may be done by taking one of the patches form the original image (e.g., a top left patch, a bottom right patch, a random patch, etc.) and applying 502 object detection such as described above in the context of FIGS. 1-4 to identify mitosis and mitosis look-alike nuclei. Once the object detection was complete, each of the identified mitosis or mitosis look-alike nuclei could then be subjected to further processing to ensure the accuracy of the method's final output. For example, as shown in FIG. 5, a determination 503 could be made of whether a mitosis or mitosis look-alike nucleus was associated with a confidence value below a low value threshold. If it was, then that nucleus may be discarded 504. For instance, in a case where the detection model identified each nucleus in a patch as either a mitosis or mitosis look-alike nucleus, and provided a confidence score corresponding to that identification, then if the confidence score was below a threshold associated with images that should have been identified as part of the background rather than either a mitosis or mitosis look-alike nucleus, that nucleus could be discarded 504 (e.g., by no longer being treated as a nucleus for the purposes of further processing by a system performing the method of FIG. 5).

If an object detected by the detection model was not discarded 504, a determination 505 may be made as to whether it was associated with a high confidence score. This may be done by comparing the confidence score associated with the object with a threshold established during training as being sufficient to indicate that the identification of that object by the detection model was correct. For example, if there was found to be a 99% or higher chance that an identification with a confidence above a particular level was correct, this level may be used as a threshold in determining 505 whether an object is associated with a high confidence score. If the object was associated with a high confidence score, then the identification of the object obtained by applying 502 the detection model could be used 506 as the final classification for the object. That is, if the detection model identified the object as a mitosis nucleus, then it may be treated as a mitosis nucleus in the final output of the method, and if the detection model identified the object as a mitosis look-alike nucleus, then it may be treated as a mitosis look-alike nucleus in the final output of the method. Alternatively, if the object was determined 505 not to have a high confidence score, then a classification model may be applied 507 to determine how it should be treated in the final output of the method. This classification model may be a detection model such as illustrated and described in the context of FIGS. 1-4, except the training data for this model may be limited to only the objects whose identification by the initial detection model was associated with a confidence which was not high enough to be classified as high, but also not low enough for those objects to be discarded (such objects being referred for ease of reference as “uncertain cases”). Alternatively, in some cases a classification model be a different type of model than the model used in the initial detection. For example, if the initial detection was performed using a RetinaNET detection model trained on a large corpus of annotated H&E stained images, then the subsequent classification may be performed using a VGG19 classification model trained using the RetinaNET's uncertain cases.

After the appropriate treatment (e.g., discarding 504, treating as having the classification provided by the detection model 506, or treated as having the classification provided by a classification model 507) of a particular nucleus had been determined, this processing could be repeated until it was determined 508 that there were no further nuclei in the particular patch being analyzed. The detection model could then be applied 502 to the next patch from the H&E stained slide image, and the overall process could be repeated until it was determined 509 that all patches had been analyzed. Once all patches had been analyzed, the process of FIG. 5 could conclude with outputting 510 an annotated image. This could be done, for example, by taking the processed patches, adding the appropriate (i.e., those determined by applying 502 the detection model if they were associated with high confidence scores, and those determined by applying 507 the classification model if they were not associated with high confidence scores but also were not discarded 504) identifications of mitosis and mitosis look alike nuclei, and reassembling them into a complete image for subsequent presentation to a physician or other applications. In this way, a process such as shown in FIG. 5 could selectively apply a secondary classification model, thereby allowing for accurate identification of mitosis and mitosis look-alike nuclei, without incurring the computational overhead cost of applying the secondary model except where the initial detection model failed to either identify an object with sufficient (or sufficiently low) confidence to allow it be classified or discarded based on the initial detection model alone.

Variations on the approaches and examples described above may also be used to provide benefits which are the same as, or similar to, those discussed above. For example, while FIG. 5 illustrated discarding 504 objects associated with confidence values below a low threshold, it is possible in some cases that objects which should be discarded will be identified as such by the detection model itself (e.g., by classifying them in a background class, or in a class which is irrelevant to, and therefore may be discarded in, a particular application), in which case a separate low confidence value determination 504 may be omitted. As another example of a potential variation, while the discussion associated with FIG. 5 described nuclei being identified as uncertain (505) and classified (507) on a nucleus by nucleus basis, it is also possible that the steps shown in FIG. 5 could be reorganized, so that all nuclei in a patch (or all nuclei in an initial slide image) would be evaluated, and then, after all of the nuclei had been evaluated, all of the nuclei evaluated as uncertain would be classified.

Variations are also possible on the types of classifications which could be performed based on this disclosure. For instance, while the examples discussed potentially classifying objects as mitosis and mitosis look-alike nuclei, it is possible in some cases that objects would be classified as mitosis nuclei only, with the confidence value associated with that classification being used to determine if any particular nucleus would actually be treated as a mitosis nucleus (e.g., if the confidence value from a detection model is above a threshold, then the nucleus would be treated as a mitosis nucleus, if the confidence value from the detection model is below a second threshold it would be discarded, and if the confidence value from the detection model is between the two values it could be provided to a secondary classification model which would provide a confidence value which would be treated as indicating mitosis nucleus if and only if it was above a threshold). Also, while the above examples discussed identifying mitosis and mitosis look-alike nuclei in H&E stained images, the same approaches could be applied to identifying mitosis and mitosis look-alike nuclei in other types of images, or to distinguishing between other types of hard to distinguish objects, either in H&E stained images or in other types of images. Accordingly the approaches and applications described above should be understood as being exemplary only, and should not be treated as limiting.

Variations are also possible on the benefits which may be obtained through use of the disclosed technology, and the benefits discussed above are not the only ones which are possible. To illustrate, consider the problem of false positives and negatives in a system that classifies mitosis nuclei based on confidence values. Because of the difficulty of identifying mitosis nuclei, with any particular threshold used to separate mitosis nuclei from other types of objects, there will be a risk that some mitosis nuclei will fall below the threshold and therefore not be identified. On the other hand, the lower the threshold, the greater the risk of a false positive identification, and so the threshold for treating an object as a mitosis nucleus maybe be set at a level which can be expected to achieve a particular balance of false negatives and false positives which is appropriate for a particular application. However, by using a method such as shown in FIG. 5, the threshold for potentially identifying a nucleus as a mitosis nucleus can be lowered below what would be expected to provide an appropriate number of false positives and false negatives using a detection model in isolation, since the classification model would be better able to distinguish uncertain cases and therefore allow for fewer false negatives without increasing the number of false positives. Similarly, the confidence level which would be used to accept a classification of mitosis nucleus from the detection model could be increased, thereby reducing the number of false positives without increasing the risk of false negatives. Accordingly, the use of a secondary classification model may improve the sensitivity and specificity of automated object detection, not only by providing classifications of a detection model's uncertain cases, but also by reducing the numbers of false positives and/or negatives produced by a detection model.

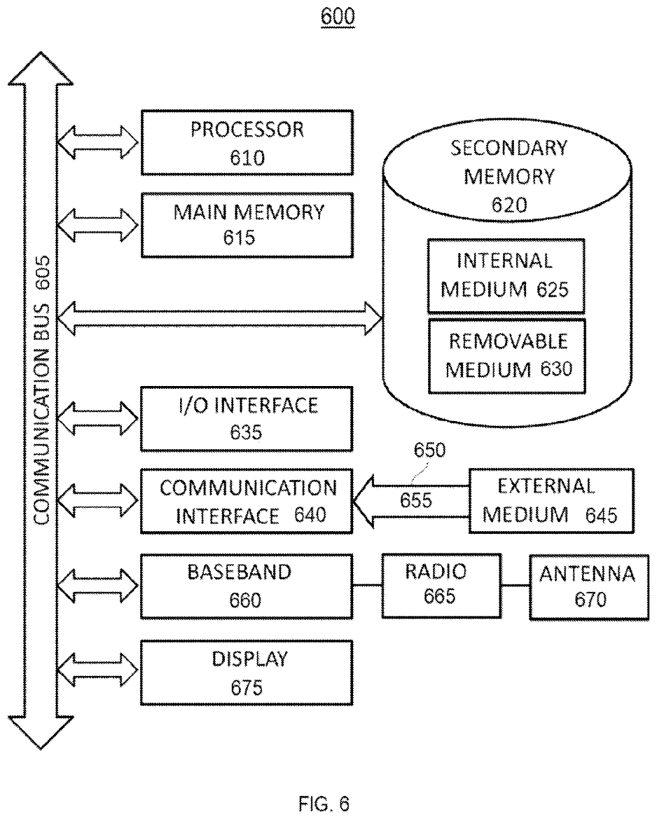

FIG. 6 is a block diagram illustrating an example computing apparatus 600 that may be used in connection with various embodiments described herein. For example, computing apparatus 600 may be programmed to perform classifications of mitosis and mitosis look-alike nuclei using software implementing architectures such as shown and discussed in the context of FIGS. 1, 2 and 4, and using methods such as shown and discussed in the context of FIGS. 3 and 5. Computing apparatus 600 can be a server or any conventional personal computer, or any other processor-enabled device that is capable of wired or wireless data communication. Other computing apparatus, systems and/or architectures may be also used, including devices that are not capable of wired or wireless data communication, as will be clear to those skilled in the art.

Computing apparatus 600 preferably includes one or more processors, such as processor 610. The processor 610 may be for example a CPU, CPU, TPU or arrays or combinations thereof such as CPU and TPU combinations or CPU and GPU combinations. Additional processors may be provided, such as an auxiliary processor to manage input/output, an auxiliary processor to perform floating point mathematical operations (e.g. a TPU), a special-purpose microprocessor having an architecture suitable for fast execution of signal processing algorithms (e.g., digital signal processor, image processor), a slave processor subordinate to the main processing system (e.g., back-end processor), an additional microprocessor or controller for dual or multiple processor systems, or a coprocessor. Such auxiliary processors may be discrete processors or may be integrated with the processor 610. Examples of CIs which may be used with computing apparatus 600 are, the Pentium processor, Core i7 processor, and Xeon processor, all of which are available from Intel Corporation of Santa Clara, Calif. An example GPU which may be used with computing apparatus 600 is Tesla KSO GPU of Nvidia Corporation, Santa Clara, Calif.

Processor 610 is connected to a communication bus 605. Communication bus 605 may include a data channel for facilitating information transfer between storage and other peripheral components of computing apparatus 500. Communication bus 505 further may provide a set of signals used for communication with processor 610, including a data bus, address bus, and control bus (not shown). Communication bus 505 may comprise any standard or non-standard bus architecture such as, for example, bus architectures compliant with industry standard architecture (ISA), extended industry standard architecture (EISA), Micro Channel Architecture (MCA), peripheral component interconnect (PI) local bus, or standards promulgated by the Institute of Electrical and Electronics Engineers (IEEE) including IEE 488 general-purpose interface bus (GPIB), IEEE 696/S-100, and the like.

Computing apparatus 600 preferably includes a main memory 615 and may also include a secondary memory 620. Main memory 615 provides storage of instructions and data for programs executing on processor 610, such as one or more of the functions and/or modules discussed above. It should be understood that computer readable program instructions stored in the memory and executed by processor 610 may be assembler instructions, instruction-set-architecture (ISA) instructions, machine instructions, machine dependent instructions, microcode, firmware instructions, state-setting data, configuration data for integrated circuitry, or either source code or object code written in and/or compiled from any combination of one or more programming languages, including without limitation Smalltalk, C/C++, Java, JavaScript, Perl, Visual Basic, NET, and the like, Main memory 615 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Secondary memory 620 may optionally include an internal memory 625 and/or a removable medium 630. Removable medium 630 is read from and/or written to in any well-known manner Removable storage medium 630 may be, for example, a magnetic tape drive, a compact disc (CD) drive, a digital versatile disc (DVD) drive, other optical drive, a flash memory drive, etc.

Removable storage medium 630 is a non-transitory computer-readable medium having stored thereon computer-executable code (i.e., software) and/or data. The computer software or data stored on removable storage medium 630 is read into computing apparatus 600 for execution by processor 610.

The secondary memory 620 may include other similar elements for allowing computer programs or other data or instructions to be loaded into computing apparatus 600. Such means may include, for example, an external storage medium 645 and a communication interface 640, which allows software and data to be transferred from external storage medium 645 to computing apparatus 600. Examples of external storage medium 645 may include an external hard disk drive, an external optical drive, an external magneto-optical drive, etc. Other examples of secondary memory 620 may include semiconductor-based memory such as programmable read-only memory (PROM), erasable programmable read-only memory (EPROM), electrically erasable read-only memory (EEPROM), or flash memory (block-oriented memory similar to EEPROM).

As mentioned above, computing apparatus 600 may include a communication interface 640. Communication interface 640 allows software and data to be transferred between computing apparatus 600 and external devices (e.g. printers), networks, or other information sources. For example, computer software or executable code may be transferred to computing apparatus 600 from a network server via communication interface 640. Examples of communication interface 640 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 550 with a network or another computing device, Communication interface 640 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 640 are generally in the form of electrical communication signals 655. These signals 555 may be provided to communication interface 640 via a communication channel 650. In an embodiment, communication channel 650 may be a wired or wireless network, or any variety of other communication links. Communication channel 650 carries signals 655 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (i.e., computer programs or software) is stored in main memory 615 and/or the secondary memory 620. Computer programs can also be received via communication interface 640 and stored in main memory 615 and/or secondary memory 620. Such computer programs, when executed, enable computing apparatus 600 to perform the various functions of the disclosed embodiments as described elsewhere herein.

In this document, the term “computer-readable medium” is used to refer to any non-transitory computer-readable storage media used to provide computer-executable code (e.g., software and computer programs) to computing apparatus 600. Examples of such media include main memory 615, secondary memory 620 (including internal memory 625, removable medium 630, and external storage medium 645), and any peripheral device communicatively coupled with communication interface 640 (including a network information server or other network device). These non-transitory computer-readable media are means for providing executable code, programming instructions, and software to computing apparatus 500. [90] In an embodiment that is implemented using software, the software may be stored on a computer-readable medium and loaded into computing apparatus 600 by way of removable medium 630, I/O interface 635, or communication interface 640. In such an embodiment, the software is loaded into computing apparatus 600 in the form of electrical communication signals 655. The software, when executed by processor 610, preferably causes processor 610 to perform the features and functions described elsewhere herein.

I/O interface 635 provides an interface between one or more components of computing apparatus 600 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (V-FDs), surface-conduction electron-emitter displays (SEDs), field emission displays (FEDs), and the like.

Computing apparatus 600 also includes optional wireless communication components that facilitate wireless communication over a voice network and/or a data network. The wireless communication components comprise an antenna system 670, a radio system 665, and a baseband system 660. In computing apparatus 600, radio frequency (RF) signals are transmitted and received over the air by antenna system 670 under the management of radio system 665.

Antenna system 670 may comprise one or more antennae and one or more multiplexors (not shown) that perform a switching function to provide antenna system 670 with transmit and receive signal paths. In the receive path, received RF signals can be coupled from a multiplexor to a low noise amplifier (not shown) that amplifies the received RF signal and sends the amplified signal to radio system 665.

Radio system 665 may comprise one or more radios that are configured to communicate over various frequencies. In an embodiment, radio system 665 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 665 to baseband system 660.

If the received signal contains audio information, then baseband system 5660 decodes the signal and converts it to an analog signal. Then the signal is amplified and sent to a speaker. Baseband system 660 also receives analog audio signals from a microphone. These analog audio signals are converted to digital signals and encoded by baseband system 660. Baseband system 660 also codes the digital signals for transmission and generates a baseband transmit audio signal that is routed to the modulator portion of radio system 665. The modulator mixes the baseband transmit audio signal with an RE carrier signal generating an RE transmit signal that is routed to antenna system 670 and may pass through a power amplifier (not shown). The power amplifier amplifies the RE transmit signal and routes it to antenna system 670 where the signal is switched to the antenna port for transmission.

Baseband system 660 is also communicatively coupled with processor 610, which may be a central processing unit (CPU). Processor 610 has access to data storage areas 615 and 620. Processor 610 is preferably configured to execute instructions (i.e., computer programs or software) that can be stored in main memory 615 or secondary memory 620. Computer programs can also be received from baseband processor 660 and stored in main memory 610 or in secondary memory 620, or executed upon receipt. Such computer programs, when executed, enable computing apparatus 600 to perform the various functions of the disclosed embodiments. For example, data storage areas 615 or 620 may include various software modules.

The computing apparatus further comprises a display 675 directly attached to the communication bus 605 which may be provided instead of or addition to any display connected to the i/O interface 635 referred to above.

Various embodiments may also be implemented primarily in hardware using, for example, components such as application specific integrated circuits (ASICs), programmable logic arrays (PLA), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit, or step is for ease of description. Specific functions or steps can be moved from one module, block, or circuit to another without departing from the invention.

As a further illustration of potential implementations and applications of the disclosed technology, the following examples are provided of non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A method for mitosis detection in tissue images with two step detection, the method comprising: a) receiving a tissue image; b) obtaining a detection output by applying a detection model to the tissue image, the detection output comprising, for each of a set of nuclei in the tissue image: i) an identification of that nucleus as undergoing mitosis; and ii) a confidence for the identification of that nucleus as undergoing mitosis; c) for each nucleus from the set of nuclei, making a certainty determination comprising determining a relationship between the confidence for that nucleus and a first threshold; d) for each nucleus from a first subset nuclei, based on the relationship between the confidence for that nucleus and the first threshold, obtaining a classification result indicating if that nucleus is undergoing mitosis by applying a classification model to that nucleus, wherein, for each nucleus from the first subset of nuclei, the confidence for that nucleus is not above the first threshold; and e) providing an output, wherein the output identifies: i) each nucleus from the set of nuclei identified in the detection output as undergoing mitosis and for which the confidence is above the first threshold; and ii) each nucleus from the first subset of nuclei indicated as undergoing mitosis in the classification result obtained for that nucleus by applying the classification model; as undergoing mitosis.

### Example 2

The method of Example 1, wherein: a) for each nucleus from the set of nuclei, the certainty determination comprises determining a relationship between the confidence for that nucleus and a second threshold, wherein the second threshold is less than the first threshold; b) the method comprises, for each nucleus from a second subset of the set of nuclei, discarding that nucleus based on the certainty determination, wherein, for each nucleus from the second subset of set of nuclei, the confidence for that nucleus is not above the second threshold; and c) for each nucleus identified in the output, the confidence for that nucleus is not below the second threshold.

### Example 3

The method of Example 1, wherein the detection output comprises, for each of a second set of nuclei in the tissue image, the detection output comprises: a) an identification of that nucleus as a mitosis look-alike nucleus; b) a confidence for the identification of that nucleus.

### Example 4

The method of Example 3, wherein the output identifies: a) each nucleus from the second set of nuclei identified in the detection output and for which the confidence is above the first threshold; and b) each nucleus from the first subset of nuclei indicated as not undergoing mitosis in the classification result obtained for that nucleus by applying the classification model; as mitosis look-alike nuclei.

### Example 5

The method of Example 1, wherein: a) the method comprises: i) obtaining a slide image; and ii) segmenting the slide image into a plurality of image patches; and b) the tissue image is an image patch from the plurality of image patches.

### Example 6

The method of Example 1, wherein applying the detection model comprises: a) obtaining a plurality of stage outputs by, for each of a plurality of resolutions: i) receiving an input feature set; ii) generating an output feature set for that resolution by applying one or more convolution filters to the input feature set; iii) generating a stage output for that resolution by downsampling the output feature set for that resolution using a pooling operation; b) generating the detection output by performing steps comprising, i) generating an identification output by, for each resolution from the plurality of resolutions: A) based on the stage output for that resolution, generating a set of object identifications for that resolution; B) obtaining an upsampled set of object identifications by upsampling the set of object identifications for that resolution; and C) generating a next stage object identification input by combining the upsampled set of object identifications with the stage output for a next higher resolution from the plurality of resolutions; wherein, for each resolution from the plurality of resolutions except a lowest resolution from the plurality of resolutions, generating the set of object identifications for that resolution based on the stage output for that resolution is performed by generating the set of object identifications based on the next stage object identification input generated by a next lower resolution from the plurality of resolutions; ii) in parallel with generating the identification output, generating a box output by, for each resolution from the plurality of resolutions: A) based on the stage output for that resolution, generating a set of bounding boxes for that resolution; B) obtaining an upsampled set of bounding boxes by upsampling the set of bounding boxes for that resolution; and C) generating a next stage bounding box input by combining the upsampled set of bounding boxes with the stage output for a next higher resolution from the plurality of resolutions; wherein, for each resolution from the plurality of resolutions except a lowest resolution from the plurality of resolutions, generating the set of bounding boxes for that resolution based on the stage output for that resolution is performed by generating the set of bounding boxes based on the next stage bounding box input generated by a next lower resolution from the plurality of resolutions; and iii) obtaining the detection output based on combining the identification output and the box output.

### Example 7

The method of Example 1, wherein the tissue image is a hematoxylin and eosin (H&E) stained image.

### Example 8

A system for mitosis detection in tissue images with two step detection, the system comprising a processor configured with a set of computer executable instructions operable to, on execution, perform a method comprising: a) receiving a tissue image; b) obtaining a detection output by applying a detection model to the tissue image, the detection output comprising, for each of a set of nuclei in the tissue image: i) an identification of that nucleus as undergoing mitosis; and ii) a confidence for the identification of that nucleus as undergoing mitosis; c) for each nucleus from the set of nuclei, making a certainty determination comprising determining a relationship between the confidence for that nucleus and a first threshold; d) for each nucleus from a first subset nuclei, based on the relationship between the confidence for that nucleus and the first threshold, obtaining a classification result indicating if that nucleus is undergoing mitosis by applying a classification model to that nucleus, wherein, for each nucleus from the first subset of nuclei, the confidence for that nucleus is not above the first threshold; and e) providing an output, wherein the output identifies: i) each nucleus from the set of nuclei identified in the detection output as undergoing mitosis and for which the confidence is above the first threshold; and ii) each nucleus from the first subset of nuclei indicated as undergoing mitosis in the classification result obtained for that nucleus by applying the classification model as undergoing mitosis.

### Example 9

The system of Example 8, wherein: a) for each nucleus from the set of nuclei, the certainty determination comprises determining a relationship between the confidence for that nucleus and a second threshold, wherein the second threshold is less than the first threshold; b) the method comprises, for each nucleus from a second subset of the set of nuclei, discarding that nucleus based on the certainty determination, wherein, for each nucleus from the second subset of set of nuclei, the confidence for that nucleus is not above the second threshold; and c) for each nucleus identified in the output, the confidence for that nucleus is not below the second threshold.

### Example 10

The system of Example 8, wherein the detection output comprises, for each of a second set of nuclei in the tissue image, the detection output comprises: a) an identification of that nucleus as a mitosis look-alike nucleus; b) a confidence for the identification of that nucleus.

### Example 11

The system of Example 10, wherein the output identifies: a) each nucleus from the second set of nuclei identified in the detection output and for which the confidence is above the first threshold; and b) each nucleus from the first subset of nuclei indicated as not undergoing mitosis in the classification result obtained for that nucleus by applying the classification model; as mitosis look-alike nuclei

### Example 12

The system of Example 8, wherein: a) the method comprises: i) obtaining a slide image; and ii) segmenting the slide image into a plurality of image patches; and b) the tissue image is an image patch from the plurality of image patches.

### Example 13

The system of Example 8, wherein applying the detection model comprises: a) obtaining a plurality of stage outputs by, for each of a plurality of resolutions: i) receiving an input feature set; ii) generating an output feature set for that resolution by applying one or more convolution filters to the input feature set; iii) generating a stage output for that resolution by downsampling the output feature set for that resolution using a pooling operation; b) generating the detection output by performing steps comprising, i) generating an identification output by, for each resolution from the plurality of resolutions: A) based on the stage output for that resolution, generating a set of object identifications for that resolution; B) obtaining an upsampled set of object identifications by upsampling the set of object identifications for that resolution; and C) generating a next stage object identification input by combining the upsampled set of object identifications with the stage output for a next higher resolution from the plurality of resolutions; wherein, for each resolution from the plurality of resolutions except a lowest resolution from the plurality of resolutions, generating the set of object identifications for that resolution based on the stage output for that resolution is performed by generating the set of object identifications based on the next stage object identification input generated by a next lower resolution from the plurality of resolutions; ii) in parallel with generating the identification output, generating a box output by, for each resolution from the plurality of resolutions: A) based on the stage output for that resolution, generating a set of bounding boxes for that resolution; B) obtaining an upsampled set of bounding boxes by upsampling the set of bounding boxes for that resolution; and C) generating a next stage bounding box input by combining the upsampled set of bounding boxes with the stage output for a next higher resolution from the plurality of resolutions; wherein, for each resolution from the plurality of resolutions except a lowest resolution from the plurality of resolutions, generating the set of bounding boxes for that resolution based on the stage output for that resolution is performed by generating the set of bounding boxes based on the next stage bounding box input generated by a next lower resolution from the plurality of resolutions; and iii) obtaining the detection output based on combining the identification output and the box output.

### Example 14

The system of Example 8, wherein the tissue image is a hematoxylin and eosin (H&E) stained image.

### Example 15

A non-transitory computer readable medium storing computer executable instructions operable to program a computer comprising a processor to perform a method, the method comprising: a) receiving a tissue image; b) obtaining a detection output by applying a detection model to the tissue image, the detection output comprising, for each of a set of nuclei in the tissue image: i) an identification of that nucleus as undergoing mitosis; and ii) a confidence for the identification of that nucleus as undergoing mitosis; c) for each nucleus from the set of nuclei, making a certainty determination comprising determining a relationship between the confidence for that nucleus and a first threshold; d) for each nucleus from a first subset nuclei, based on the relationship between the confidence for that nucleus and the first threshold, obtaining a classification result indicating if that nucleus is undergoing mitosis by applying a classification model to that nucleus, wherein, for each nucleus from the first subset of nuclei, the confidence for that nucleus is not above the first threshold; and e) providing an output, wherein the output identifies: i) each nucleus from the set of nuclei identified in the detection output as undergoing mitosis and for which the confidence is above the first threshold; and ii) each nucleus from the first subset of nuclei indicated as undergoing mitosis in the classification result obtained for that nucleus by applying the classification model as undergoing mitosis.

### Example 16

The non-transitory computer readable medium of Example 15, wherein: a) for each nucleus from the set of nuclei, the certainty determination comprises determining a relationship between the confidence for that nucleus and a second threshold, wherein the second threshold is less than the first threshold; b) the method comprises, for each nucleus from a second subset of the set of nuclei, discarding that nucleus based on the certainty determination, wherein, for each nucleus from the second subset of set of nuclei, the confidence for that nucleus is not above the second threshold; and c) for each nucleus identified in the output, the confidence for that nucleus is not below the second threshold.

### Example 17

The non-transitory computer readable medium of Example 15, wherein the detection output comprises, for each of a second set of nuclei in the tissue image, the detection output comprises: a) an identification of that nucleus as a mitosis look-alike nucleus; b) a confidence for the identification of that nucleus.

### Example 18

The non-transitory computer readable medium of Example 17, wherein the output identifies: a) each nucleus from the second set of nuclei identified in the detection output and for which the confidence is above the first threshold; and b) each nucleus from the first subset of nuclei indicated as not undergoing mitosis in the classification result obtained for that nucleus by applying the classification model as mitosis look-alike nuclei.

### Example 19

The non-transitory computer readable medium of Example 15, wherein: a) the method comprises: i) obtaining a slide image; and ii) segmenting the slide image into a plurality of image patches; and b) the tissue image is an image patch from the plurality of image patches.

### Example 20

The non-transitory computer readable medium of Example 15, wherein applying the detection model comprises: a) obtaining a plurality of stage outputs by, for each of a plurality of resolutions: i) receiving an input feature set; ii) generating an output feature set for that resolution by applying one or more convolution filters to the input feature set; iii) generating a stage output for that resolution by downsampling the output feature set for that resolution using a pooling operation; b) generating the detection output by performing steps comprising, i) generating an identification output by, for each resolution from the plurality of resolutions: A) based on the stage output for that resolution, generating a set of object identifications for that resolution; B) obtaining an upsampled set of object identifications by upsampling the set of object identifications for that resolution; and C) generating a next stage object identification input by combining the upsampled set of object identifications with the stage output for a next higher resolution from the plurality of resolutions; wherein, for each resolution from the plurality of resolutions except a lowest resolution from the plurality of resolutions, generating the set of object identifications for that resolution based on the stage output for that resolution is performed by generating the set of object identifications based on the next stage object identification input generated by a next lower resolution from the plurality of resolutions; ii) in parallel with generating the identification output, generating a box output by, for each resolution from the plurality of resolutions: A) based on the stage output for that resolution, generating a set of bounding boxes for that resolution; B) obtaining an upsampled set of bounding boxes by upsampling the set of bounding boxes for that resolution; and C) generating a next stage bounding box input by combining the upsampled set of bounding boxes with the stage output for a next higher resolution from the plurality of resolutions; wherein, for each resolution from the plurality of resolutions except a lowest resolution from the plurality of resolutions, generating the set of bounding boxes for that resolution based on the stage output for that resolution is performed by generating the set of bounding boxes based on the next stage bounding box input generated by a next lower resolution from the plurality of resolutions; and iii) obtaining the detection output based on combining the identification output and the box output.

Each of the calculations or operations described herein may be performed using a computer or other processor having hardware, software, and/or firmware. The various method steps may be performed by modules, and the modules may comprise any of a wide variety of digital and/or analog data processing hardware and/or software arranged to perform the method steps described herein. The modules optionally comprising data processing hardware adapted to perform one or more of these steps by having appropriate machine programming code associated therewith, the modules for two or more steps (or portions of two or more steps) being integrated into a single processor board or separated into different processor boards in any of a wide variety of integrated and/or distributed processing architectures. These methods and systems will often employ a tangible media embodying machine-readable code with instructions for performing the method steps described above. Suitable tangible media may comprise a memory (including a volatile memory and/or a non-volatile memory), a storage media (such as a magnetic recording on a floppy disk, a hard disk, a tape, or the like; on an optical memory such as a CD, a CD-R/W, a CD-ROM, a DVD, or the like; or any other digital or analog storage media), or the like.

All patents, patent publications, patent applications, journal articles, books, technical references, and the like discussed in the instant disclosure are incorporated herein by reference in their entirety for all purposes.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. In certain cases, method steps or operations may be performed or executed in differing order, or operations may be added, deleted or modified. It can be appreciated that, in certain aspects of the invention, a single component may be replaced by multiple components, and multiple components may be replaced by a single component, to provide an element or structure or to perform a given function or functions. Except where such substitution would not be operative to practice certain embodiments of the invention, such substitution is considered within the scope of the invention. Accordingly, the claims should not be treated as limited to the examples, drawings, embodiments and illustrations provided above, but instead should be understood as having the scope provided when their terms are given their broadest reasonable interpretation as provided by a general-purpose dictionary, except that when a term or phrase is indicated as having a particular meaning under the heading Explicit Definitions, it should be understood as having that meaning when used in the claims.

### Explicit Definitions

It should be understood that, in the above examples and the claims, a statement that something is “based on” something else should be understood to mean that it is determined at least in part by the thing that it is indicated as being based on. To indicate that something must be completely determined based on something else, it is described as being “based EXCLUSIVELY on” whatever it must be completely determined by.

It should be understood that, in the above examples and claims, the term “mitosis look-alike” should be understood as a nucleus which is not undergoing mitosis, but which has one or more characteristics consistent with undergoing mitosis.

It should be understood that, in the above examples and claims, the term “set” should be understood as zero or more things which are grouped together. The terms “subset” and “superset” should be understood as being synonymous with “set,” with “set,” “subset” or “superset” being used for ease of reference rather than to convey a substantive difference.

What is claimed is:

1. A method for mitosis detection in tissue images with two step detection, the method comprising:
a) receiving a tissue image;
b) obtaining a detection output by applying a detection model to the tissue image, the detection output comprising, for each of a set of nuclei in the tissue image:
i) an identification of that nucleus as undergoing mitosis; and
ii) a confidence for the identification of that nucleus as undergoing mitosis;
c) for each nucleus from the set of nuclei, making a certainty determination comprising determining a relationship between the confidence for that nucleus and a first threshold;
d) for each nucleus from a first subset nuclei, based on the relationship between the confidence for that nucleus and the first threshold, obtaining a classification result indicating if that nucleus is undergoing mitosis by applying a classification model to that nucleus, wherein, for each nucleus from the first subset of nuclei, the confidence for that nucleus is not above the first threshold; and
e) providing an output, wherein the output identifies:
i) each nucleus from the set of nuclei identified in the detection output as undergoing mitosis and for which the confidence is above the first threshold; and
ii) each nucleus from the first subset of nuclei indicated as undergoing mitosis in the classification result obtained for that nucleus by applying the classification model
as undergoing mitosis.

2. The method of claim 1, wherein:
a) for each nucleus from the set of nuclei, the certainty determination comprises determining a relationship between the confidence for that nucleus and a second threshold, wherein the second threshold is less than the first threshold;
b) the method comprises, for each nucleus from a second subset of the set of nuclei, discarding that nucleus based on the certainty determination, wherein, for each nucleus from the second subset of set of nuclei, the confidence for that nucleus is not above the second threshold; and
c) for each nucleus identified in the output, the confidence for that nucleus is not below the second threshold.

3. The method of claim 1, wherein the detection output comprises, for each of a second set of nuclei in the tissue image, the detection output comprises:
a) an identification of that nucleus as a mitosis look-alike nucleus;
b) a confidence for the identification of that nucleus.

4. The method of claim 3, wherein the output identifies:
a) each nucleus from the second set of nuclei identified in the detection output and for which the confidence is above the first threshold; and
b) each nucleus from the first subset of nuclei indicated as not undergoing mitosis in the classification result obtained for that nucleus by applying the classification model
as mitosis look-alike nuclei.

5. The method of claim 1, wherein:
a) the method comprises:
i) obtaining a slide image; and
ii) segmenting the slide image into a plurality of image patches; and
b) the tissue image is an image patch from the plurality of image patches.

6. The method of claim 1, wherein applying the detection model comprises:
a) obtaining a plurality of stage outputs by, for each of a plurality of resolutions:
i) receiving an input feature set;
ii) generating an output feature set for that resolution by applying one or more convolution filters to the input feature set;
iii) generating a stage output for that resolution by downsampling the output feature set for that resolution using a pooling operation;
b) generating the detection output by performing steps comprising,
i) generating an identification output by, for each resolution from the plurality of resolutions:
A) based on the stage output for that resolution, generating a set of object identifications for that resolution;
B) obtaining an upsampled set of object identifications by upsampling the set of object identifications for that resolution; and
C) generating a next stage object identification input by combining the upsampled set of object identifications with the stage output for a next higher resolution from the plurality of resolutions;
wherein, for each resolution from the plurality of resolutions except a lowest resolution from the plurality of resolutions, generating the set of object identifications for that resolution based on the stage output for that resolution is performed by generating the set of object identifications based on the next stage object identification input generated by a next lower resolution from the plurality of resolutions;
ii) in parallel with generating the identification output, generating a box output by, for each resolution from the plurality of resolutions:
A) based on the stage output for that resolution, generating a set of bounding boxes for that resolution;
B) obtaining an upsampled set of bounding boxes by upsampling the set of bounding boxes for that resolution; and
C) generating a next stage bounding box input by combining the upsampled set of bounding boxes with the stage output for a next higher resolution from the plurality of resolutions;
wherein, for each resolution from the plurality of resolutions except a lowest resolution from the plurality of resolutions, generating the set of bounding boxes for that resolution based on the stage output for that resolution is performed by generating the set of bounding boxes based on the next stage bounding box input generated by a next lower resolution from the plurality of resolutions;
and
iii) obtaining the detection output based on combining the identification output and the box output.

7. The method of claim 1, wherein the tissue image is a hematoxylin and eosin (H&E) stained image.

8. A system for mitosis detection in tissue images with two step detection, the system comprising a processor configured with a set of computer executable instructions operable to, on execution, perform a method comprising:
a) receiving a tissue image;
b) obtaining a detection output by applying a detection model to the tissue image, the detection output comprising, for each of a set of nuclei in the tissue image:
i) an identification of that nucleus as undergoing mitosis; and
ii) a confidence for the identification of that nucleus as undergoing mitosis;
c) for each nucleus from the set of nuclei, making a certainty determination comprising determining a relationship between the confidence for that nucleus and a first threshold;
d) for each nucleus from a first subset nuclei, based on the relationship between the confidence for that nucleus and the first threshold, obtaining a classification result indicating if that nucleus is undergoing mitosis by applying a classification model to that nucleus, wherein, for each nucleus from the first subset of nuclei, the confidence for that nucleus is not above the first threshold; and
e) providing an output, wherein the output identifies:
i) each nucleus from the set of nuclei identified in the detection output as undergoing mitosis and for which the confidence is above the first threshold; and
ii) each nucleus from the first subset of nuclei indicated as undergoing mitosis in the classification result obtained for that nucleus by applying the classification model
as undergoing mitosis.

9. The system of claim 8, wherein:
a) for each nucleus from the set of nuclei, the certainty determination comprises determining a relationship between the confidence for that nucleus and a second threshold, wherein the second threshold is less than the first threshold;
b) the method comprises, for each nucleus from a second subset of the set of nuclei, discarding that nucleus based on the certainty determination, wherein, for each nucleus from the second subset of set of nuclei, the confidence for that nucleus is not above the second threshold; and
c) for each nucleus identified in the output, the confidence for that nucleus is not below the second threshold.

10. The system of claim 8, wherein the detection output comprises, for each of a second set of nuclei in the tissue image, the detection output comprises:
a) an identification of that nucleus as a mitosis look-alike nucleus;
b) a confidence for the identification of that nucleus.

11. The system of claim 10, wherein the output identifies:
a) each nucleus from the second set of nuclei identified in the detection output and for which the confidence is above the first threshold; and
b) each nucleus from the first subset of nuclei indicated as not undergoing mitosis in the classification result obtained for that nucleus by applying the classification model
as mitosis look-alike nuclei.

12. The system of claim 8, wherein:
a) the method comprises:
i) obtaining a slide image; and
ii) segmenting the slide image into a plurality of image patches;
and
b) the tissue image is an image patch from the plurality of image patches.

13. The system of claim 8, wherein applying the detection model comprises:
a) obtaining a plurality of stage outputs by, for each of a plurality of resolutions:
i) receiving an input feature set;
ii) generating an output feature set for that resolution by applying one or more convolution filters to the input feature set;
iii) generating a stage output for that resolution by downsampling the output feature set for that resolution using a pooling operation;
b) generating the detection output by performing steps comprising,
i) generating an identification output by, for each resolution from the plurality of resolutions:
A) based on the stage output for that resolution, generating a set of object identifications for that resolution;
B) obtaining an upsampled set of object identifications by upsampling the set of object identifications for that resolution; and
C) generating a next stage object identification input by combining the upsampled set of object identifications with the stage output for a next higher resolution from the plurality of resolutions;
wherein, for each resolution from the plurality of resolutions except a lowest resolution from the plurality of resolutions, generating the set of object identifications for that resolution based on the stage output for that resolution is performed by generating the set of object identifications based on the next stage object identification input generated by a next lower resolution from the plurality of resolutions;
ii) in parallel with generating the identification output, generating a box output by, for each resolution from the plurality of resolutions:
A) based on the stage output for that resolution, generating a set of bounding boxes for that resolution;
B) obtaining an upsampled set of bounding boxes by upsampling the set of bounding boxes for that resolution; and
C) generating a next stage bounding box input by combining the upsampled set of bounding boxes with the stage output for a next higher resolution from the plurality of resolutions;
wherein, for each resolution from the plurality of resolutions except a lowest resolution from the plurality of resolutions, generating the set of bounding boxes for that resolution based on the stage output for that resolution is performed by generating the set of bounding boxes based on the next stage bounding box input generated by a next lower resolution from the plurality of resolutions;
and
iii) obtaining the detection output based on combining the identification output and the box output.

14. The system of claim 8, wherein the tissue image is a hematoxylin and eosin (H&E) stained image.

15. A non-transitory computer readable medium storing computer executable instructions operable to program a computer comprising a processor to perform a method, the method comprising:
a) receiving a tissue image;
b) obtaining a detection output by applying a detection model to the tissue image, the detection output comprising, for each of a set of nuclei in the tissue image:
i) an identification of that nucleus as undergoing mitosis; and
ii) a confidence for the identification of that nucleus as undergoing mitosis;
c) for each nucleus from the set of nuclei, making a certainty determination comprising determining a relationship between the confidence for that nucleus and a first threshold;
d) for each nucleus from a first subset nuclei, based on the relationship between the confidence for that nucleus and the first threshold, obtaining a classification result indicating if that nucleus is undergoing mitosis by applying a classification model to that nucleus, wherein, for each nucleus from the first subset of nuclei, the confidence for that nucleus is not above the first threshold; and
e) providing an output, wherein the output identifies:
i) each nucleus from the set of nuclei identified in the detection output as undergoing mitosis and for which the confidence is above the first threshold; and
ii) each nucleus from the first subset of nuclei indicated as undergoing mitosis in the classification result obtained for that nucleus by applying the classification model
as undergoing mitosis.

16. The non-transitory computer readable medium of claim 15, wherein:
a) for each nucleus from the set of nuclei, the certainty determination comprises determining a relationship between the confidence for that nucleus and a second threshold, wherein the second threshold is less than the first threshold;
b) the method comprises, for each nucleus from a second subset of the set of nuclei, discarding that nucleus based on the certainty determination, wherein, for each nucleus from the second subset of set of nuclei, the confidence for that nucleus is not above the second threshold; and
c) for each nucleus identified in the output, the confidence for that nucleus is not below the second threshold.

17. The non-transitory computer readable medium of claim 15, wherein the detection output comprises, for each of a second set of nuclei in the tissue image, the detection output comprises:
a) an identification of that nucleus as a mitosis look-alike nucleus;
b) a confidence for the identification of that nucleus.

18. The non-transitory computer readable medium of claim 17, wherein the output identifies:
a) each nucleus from the second set of nuclei identified in the detection output and for which the confidence is above the first threshold; and
b) each nucleus from the first subset of nuclei indicated as not undergoing mitosis in the classification result obtained for that nucleus by applying the classification model
as mitosis look-alike nuclei.

19. The non-transitory computer readable medium of claim 15, wherein:
a) the method comprises:
i) obtaining a slide image; and
ii) segmenting the slide image into a plurality of image patches;
and
b) the tissue image is an image patch from the plurality of image patches.

20. The non-transitory computer readable medium of claim 15, wherein applying the detection model comprises:
a) obtaining a plurality of stage outputs by, for each of a plurality of resolutions:
i) receiving an input feature set;
ii) generating an output feature set for that resolution by applying one or more convolution filters to the input feature set;
iii) generating a stage output for that resolution by downsampling the output feature set for that resolution using a pooling operation;
b) generating the detection output by performing steps comprising,
i) generating an identification output by, for each resolution from the plurality of resolutions:
A) based on the stage output for that resolution, generating a set of object identifications for that resolution;
B) obtaining an upsampled set of object identifications by upsampling the set of object identifications for that resolution; and
C) generating a next stage object identification input by combining the upsampled set of object identifications with the stage output for a next higher resolution from the plurality of resolutions;
wherein, for each resolution from the plurality of resolutions except a lowest resolution from the plurality of resolutions, generating the set of object identifications for that resolution based on the stage output for that resolution is performed by generating the set of object identifications based on the next stage object identification input generated by a next lower resolution from the plurality of resolutions;
ii) in parallel with generating the identification output, generating a box output by, for each resolution from the plurality of resolutions:
A) based on the stage output for that resolution, generating a set of bounding boxes for that resolution;
B) obtaining an upsampled set of bounding boxes by upsampling the set of bounding boxes for that resolution; and
C) generating a next stage bounding box input by combining the upsampled set of bounding boxes with the stage output for a next higher resolution from the plurality of resolutions;
wherein, for each resolution from the plurality of resolutions except a lowest resolution from the plurality of resolutions, generating the set of bounding boxes for that resolution based on the stage output for that resolution is performed by generating the set of bounding boxes based on the next stage bounding box input generated by a next lower resolution from the plurality of resolutions;
and
iii) obtaining the detection output based on combining the identification output and the box output.
